(19) United States
(12) Patent Application Publication
(10) Pub. No.: US 2012/0309552 A1
(43) Pub. Date: Dec. 6, 2012

(54) BOWLING BALANCER

(76) Inventor: Thomas Flynn, Alhambra, CA (US)

(21) Appl. No.: 13/586,822

(22) Filed: Aug. 15, 2012

Related U.S. Application Data
(63) Continuation-in-part of application No. 29/349,452, filed on Jun. 24, 2010, now abandoned.

(51) Int. Cl. A61G 5/14; A63D 5/00

(52) U.S. Cl. 473/56

(57) ABSTRACT

A bowling support apparatus with a circular plate. The bowling support apparatus further includes a plurality of legs coupled with the circular plate, where the plurality of legs extends from said circular plate in a downward direction. The bowling support apparatus further includes pole coupled with the circular plate, where said pole extends substantially perpendicularly from the circular plate in an upward direction. The bowling support apparatus further includes a handle coupled with the pole.

The present application is a continuation-in-part of U.S. patent application Ser. No. 29/349,452, filed on Jun. 24, 2010, which is herein incorporated by reference for completeness of disclosure.

### BACKGROUND OF THE INVENTION

1. Field of the Invention

Embodiments of the invention described herein pertain to the field of sporting goods. More particularly, but not by way of limitation, one or more embodiments of the invention enable a bowling balancer.

2. Description of the Related Art

Bowling is a popular past time. Bowling requires a certain level of physical fitness and general physical ability, including balance. Age, degenerative diseases, strokes, accidents, and other factors can affect a person's level of physical fitness or general physical ability, resulting in impairment during activities such as bowling. For example, individuals who have suffered a stroke may have unilateral balance issues, making the probability of a fall higher when engaging in bowling.

Such an individual may still participate in a restricted manner, such as by standing at the edge of the bowling lane to release the bowling ball. However, there is still a great risk of falling for such an individual.

To overcome the problems and limitations described above there is a need for a BOWLING BALANCER.

### BRIEF SUMMARY OF THE INVENTION

One or more embodiments of the bowling support apparatus described herein are directed to a bowling support apparatus including a circular plate. In one or more embodiments, the circular plate has a diameter of about 12 inches.

The bowling support apparatus further includes a plurality of legs coupled with the circular plate, where the plurality of legs extends from the circular plate in a downward direction. In one or more embodiments, the plurality of legs includes at least five legs. The plurality of legs may consist of six legs. In one or more embodiments, the plurality of legs each have a length of about 4 inches. In one or more embodiments, the plurality of legs form a connected base unit where each leg includes a horizontal portion extending from a center point of the connected base unit, where each leg contacts the circular plate at the horizontal portion.

The bowling support apparatus further includes a pole coupled with the circular plate, where the pole extends substantially perpendicularly from the circular plate in an upward direction. In one or more embodiments, the pole has a length of about 23 inches.

The bowling support apparatus further includes a handle coupled with the pole. In one or more embodiments, the handle is coupled with the pole at about a midpoint of the handle. The handle may extend about five inches from the midpoint of the handle. In one or more embodiments, the bowling support apparatus further includes at least one soft handle bar grip coupled with the handle.

In one or more embodiments, the bowling support apparatus further includes a plurality of rubber boots configured to couple with the plurality of legs.

In one or more embodiments, the circular plate, the pole, the handle, and the legs are made of metal.

One or more embodiments of the bowling support apparatus described herein are directed to a bowling support apparatus including a circular plate, six legs coupled with the circular plate, where the circular plate is metal, where the six legs extend from the circular plate in a downward direction, six rubber boots configured to couple with the six legs, a pole coupled with the circular plate, where the pole extends substantially perpendicularly from the circular plate in an upward direction, and a handle coupled with the pole.

The six legs may form a connected base unit where each leg includes a horizontal portion extending from a center point of the connected base unit, where each leg contacts the circular plate at the horizontal portion.

### BRIEF DESCRIPTION OF THE DRAWINGS

The above and other aspects, features and advantages of the invention will be more apparent from the following more particular description thereof, presented in conjunction with the following drawings wherein:

FIG. 1 is a perspective view of an exemplary bowling support apparatus in accordance with one or more embodiments of the bowing balancer described herein.

FIG. 2 is a bottom side view of an exemplary bowling support apparatus in accordance with one or more embodiments of the bowing balancer described herein.

FIG. 3 is a top side view of an exemplary bowling support apparatus in accordance with one or more embodiments of the bowing balancer described herein.

FIG. 4 is a front side view of an exemplary bowling support apparatus in accordance with one or more embodiments of the bowing balancer described herein.

FIG. 5 is a side view of an exemplary bowling support apparatus in accordance with one or more embodiments of the bowing balancer described herein.

### DETAILED DESCRIPTION

A BOWLING BALANCER will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary kill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

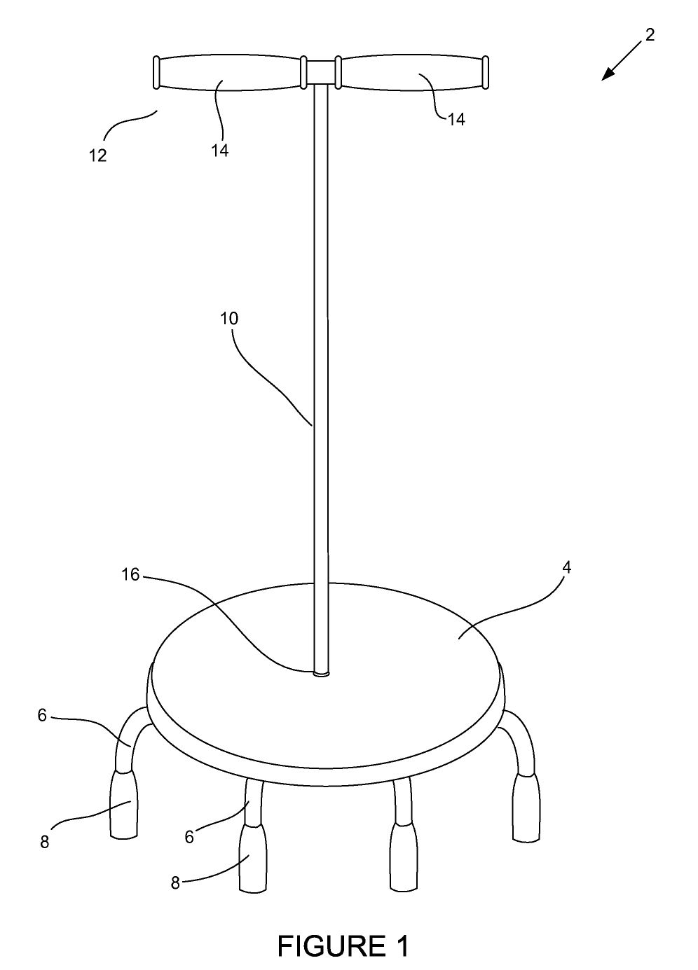

FIG. 1 is a perspective view of an exemplary bowling support apparatus in accordance with one or more embodiments of the bowing balancer described herein.

Bowling support apparatus 2 includes circular plate 4. In a preferred embodiment, circular plate 4 is substantially made of a metal, such as steel, stainless steel, aluminum, metal alloy, or any other metal. Circular plate 4 may also be made of any other suitable material for making a support apparatus for a human, such as plastic, composite, wood, or any other suitable material.

In one or more embodiments, circular plate 4 may be replaced with a plate of any shape, such as a square, triangle, hexagon, or any other suitable shape without departing from the spirit or scope of the invention. A suitable shape is preferably a substantially equilateral polygon.

One or more coatings or attachments, such as rubber, paint, powder, or any other coating or attachment, may be coupled with or disposed on circular plate 4 without departing from the spirit or the scope of the invention.

In a preferred embodiment, circular plate 4 is about 12 inches in diameter. Circular plate 4 may also be between about 10 inches in diameter to about 14 inches in diameter, or alternatively between about 10 inches in diameter to about 18 inches in diameter.

Bowling support apparatus 2 also includes a plurality of legs 6. Legs 6 are coupled with circular plate 4. Legs 6 are configured to extend from circular plate 4 in a downward direction. In one or more embodiments, bowling support apparatus 2 includes at least five legs 6. The plurality of legs may consist of six legs 6.

In a preferred embodiment, legs 6 is substantially made of a metal, such as steel, stainless steel, aluminum, metal alloy, or any other metal. Legs 6 may also be made of any other suitable material for making a support apparatus for a human, such as plastic, composite, wood, or any other suitable material.

One or more coatings or attachments, such as rubber, paint, powder, or any other coating or attachment, may be coupled with or disposed on legs 6 without departing from the spirit or the scope of the invention.

In one or more embodiments, bowling support apparatus 2 further includes rubber boots 8 configured to couple with legs 6. Alternatively, boots made of any material suitable for providing traction may be coupled with legs 6.

In a preferred embodiment, each leg 6 is about 4 inches in length. Legs 6 may also be between about 3 inches in length to about 6 inches in length, or alternatively between about 3 inches in length to about 8 inches in length.

Bowling support apparatus 2 further includes pole 10. Pole 10 is coupled with circular plate 4. In one or more embodiments, pole 10 is coupled with circular plate 4 through hole 16. Hole 16 is preferably located in the center of circular plate 4. In one or more embodiments, one or more couplers, such as nuts, bolts, screws, threading, or any other coupler, is used to couple pole 10 with circular plate 4 through hole 16. Pole 10 is configured to extend substantially perpendicularly from circular plate 4 in an upward direction.

In a preferred embodiment, pole 10 is substantially made of a metal, such as steel, stainless steel, aluminum, metal alloy, or any other metal. Pole 10 may also be made of any other suitable material for making a support apparatus for a human, such as plastic, composite, wood, or any other suitable material.

One or more coatings or attachments, such as rubber, paint, powder, or any other coating or attachment, may be coupled with or disposed on pole 10 without departing from the spirit or the scope of the invention.

In a preferred embodiment, pole 10 is about 23 inches in length. Pole 10 may also be between about 21 inches in length to about 25 inches in length, or alternatively between about 19 inches in length to about 28 inches in length. In one or more embodiments, pole 10 includes two or more telescoping components configured to adjust to any length in a range, such as the range of between about 21 inches to about 25 inches, or alternatively the range of between about 19 inches to about 28 inches.

The bowling support apparatus 2 further includes handle 12. Handle 12 is coupled with pole 10.

In a preferred embodiment, handle 12 is substantially made of a metal, such as steel, stainless steel, aluminum, metal alloy, or any other metal. Handle 12 may also be made of any other suitable material for making a support apparatus for a human, such as plastic, composite, wood, or any other suitable material.

One or more coatings or attachments, such as rubber, paint, powder, or any other coating or attachment, may be coupled with or disposed on handle 12 without departing from the spirit or the scope of the invention.

In one or more embodiments, handle 12 is coupled with pole 10 at about the midpoint of handle 12. In a preferred embodiment, handle 12 extends about 5 inches in opposite directions from the midpoint of handle 12. Alternatively, handle 12 extends from between about 4 inches to about 6 inches, or alternatively between about 4 inches to about 8 inches, in opposite directions from the midpoint of handle 12.

In one or more embodiments, bowling support apparatus 2 further includes at least one soft handle bar grip 14 coupled with the handle. Soft handlebar grip 14 maybe made of silicone, rubber, foam, or any other suitable material.

In one or more embodiments, bowling support apparatus 2 is provided to the consumer in a disassembled set of components configured to assemble into the form shown in FIGS. 1-5.

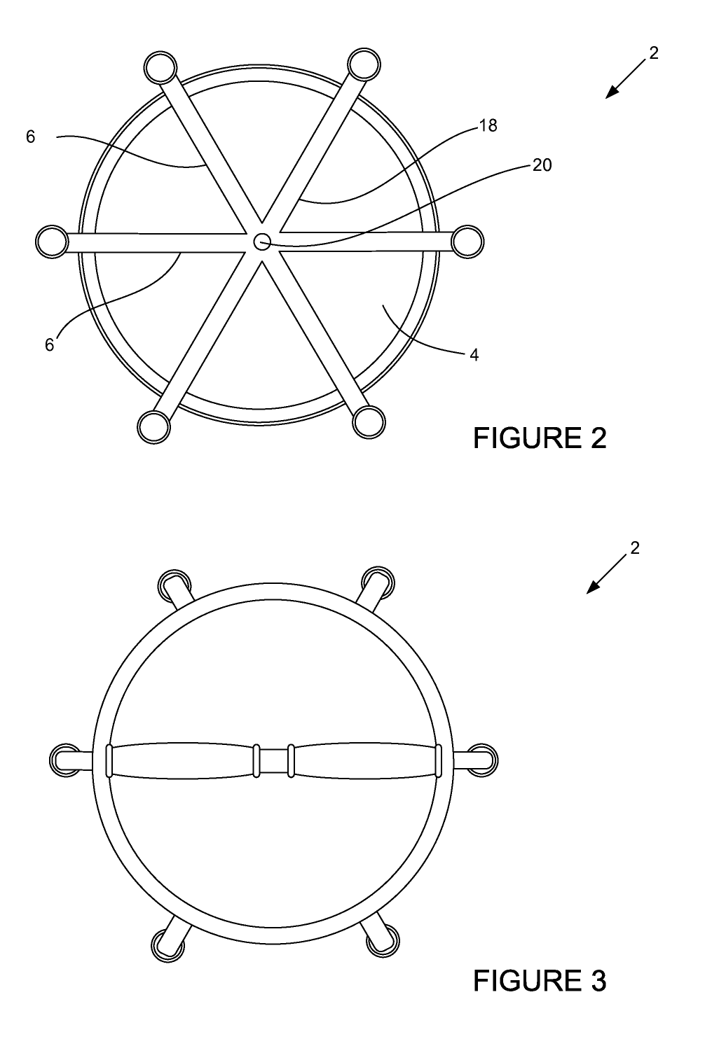

FIG. 2 is a bottom side view of an exemplary bowling support apparatus in accordance with one or more embodiments of the bowing balancer described herein.

In one or more embodiments, the plurality of legs 6 form connected base unit 18. Each leg 6 of connected base unit 18 includes a substantially horizontal portion extending from a center point 20 of connected base unit 18. Each leg 6 of connected base unit 18 circular plate 4 at its horizontal portion. In one or more embodiments, connected base unit 18 includes six legs 6 spaced at about 60° apart.

FIG. 3 is a top side view of an exemplary bowling support apparatus in accordance with one or more embodiments of the bowing balancer described herein.

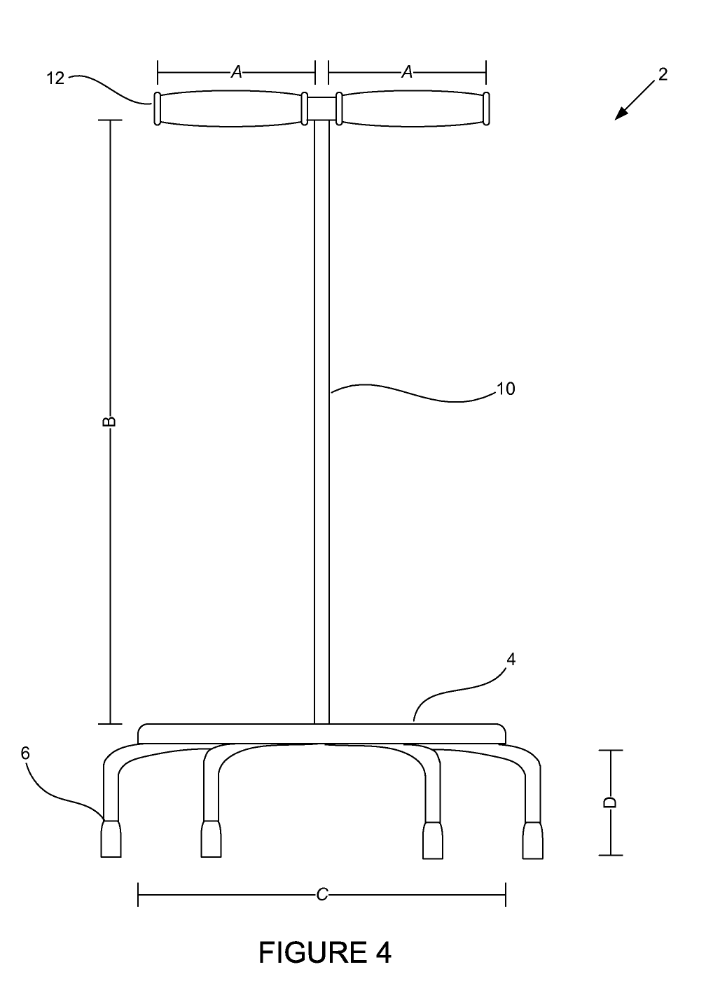

FIG. 4 is a front side view of an exemplary bowling support apparatus in accordance with one or more embodiments of the bowing balancer described herein.

In one or more embodiments, dimension A refers to a distance that handle 12 extends in opposite directions from the midpoint of handle 12 when handle 12 is coupled with pole 10 at a midpoint of handle 12. In a preferred embodiment, dimension A is about 5 inches. Dimension A may be between about 4 inches to about 6 inches, or alternatively between about 4 inches to about 8 inches.

In one or more embodiments, dimension B refers to a length of pole 10, including a total length of pole 10 in one or more embodiments where pole 10 includes two or more adjustable components. In a preferred embodiment, dimension B is about 23 inches. Dimension B may be between about 21 inches to about 25 inches, or alternatively between about 19 inches to about 28 inches.

In one or more embodiments, dimension C refers to a diameter of circular plate 4. In a preferred embodiment, dimension C is about 12 inches. Dimension C may be between about 10 inches in diameter to about 14 inches, or alternatively between about 10 inches to about 18 inches. Where circular plate 4 is replaced with a plate of an alternate shape, dimension C may be converted to a surface area.

In one or more embodiments, dimension D refers to a length of legs 6. In a preferred embodiment, dimension D is about 4 inches. Dimension D may be between about 3 inches to about 6 inches, or alternatively between about 3 inches to about 8 inches.

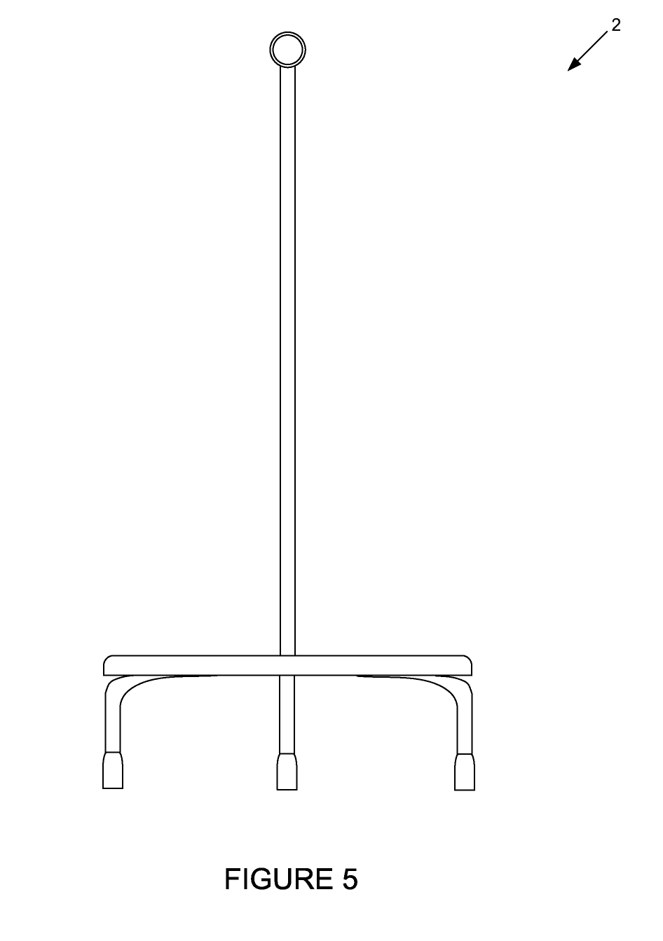

FIG. 5 is a side view of an exemplary bowling support apparatus in accordance with one or more embodiments of the bowing balancer described herein.

While the invention herein disclosed has been described by means of specific embodiments and applications thereof, numerous modifications and variations could be made thereto by those skilled in the art without departing from the scope of the invention set forth in the claims.

What is claimed is:

1. A bowling support apparatus comprising:
a circular plate;
a plurality of legs coupled with said circular plate, wherein said plurality of legs extends from said circular plate in a downward direction;
a pole coupled with said circular plate, wherein said pole extends substantially perpendicularly from said circular plate in an upward direction; and
a handle coupled with said pole.

2. The bowling support apparatus of claim 1, wherein said circular plate, said pole, said handle, and said legs comprise metal.

3. The bowling support apparatus of claim 1, further comprising a plurality of rubber boots configured to couple with said plurality of legs.

4. The bowling support apparatus of claim 1, wherein said plurality of legs comprise at least five legs.

5. The bowling support apparatus of claim 1, wherein said plurality of legs consists of six legs.

6. The bowling support apparatus of claim 1, wherein said a handle is coupled with said pole at about a midpoint of said handle.

7. The bowling support apparatus of claim 6, wherein said a handle extends about five inches from said midpoint of said handle.

8. The bowling support apparatus of claim 1, further comprising at least one soft handle bar grip coupled with said handle.

9. The bowling support apparatus of claim 1, wherein said a pole has a length of about 23 inches.

10. The bowling support apparatus of claim 1, wherein said circular plate has a diameter of about 12 inches.

11. The bowling support apparatus of claim 1, wherein said plurality of legs have a length of about 4 inches.

12. The bowling support apparatus of claim 1, wherein said plurality of legs form a connected base unit wherein each leg comprises a horizontal portion extending from a center point of said connected base unit, wherein each leg contacts said circular plate at said horizontal portion.

13. A bowling support apparatus comprising:
a circular plate;
six legs coupled with said circular plate, wherein said circular plate is metal, wherein said six legs extend from said circular plate in a downward direction;
six rubber boots configured to couple with said six legs;
a pole coupled with said circular plate, wherein said pole extends substantially perpendicularly from said circular plate in an upward direction; and
a handle coupled with said pole.

14. The bowling support apparatus of claim 13, wherein said six legs form a connected base unit wherein each leg comprises a horizontal portion extending from a center point of said connected base unit, wherein each leg contacts said circular plate at said horizontal portion.
